(19) United States
(12) Patent Application Publication
(10) Pub. No.: US 2010/0114343 A1
(43) Pub. Date: May 6, 2010

(54) AUDIO PROCESSING SYSTEM

(75) Inventors: Lung Dai, Tu-Cheng (TW); Shao-Lin Zhang, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/562,071

(22) Filed: Sep. 17, 2009

(30) Foreign Application Priority Data
Oct. 30, 2008 (CN) 200810305283.5

(51) Int. Cl. G06F 17/00

(52) U.S. Cl. 700/94

(57) ABSTRACT

An audio processing system includes an input unit, a control unit, an audio reproducing unit, an I/O processing unit, and a switch unit. The input unit receives instructions from a user and generates a first signal or a second signal in response to the instructions. The control unit generates a first trigger signal or a second trigger signal according to the first signal or the second signal, respectively. According to the first trigger signal, the audio reproducing unit decodes a plurality of audio files into internal audio signals, and the I/O processing unit selectively outputs the internal audio signals to a first external device. According to the second trigger signal, the I/O processing unit selectively inputs external audio signals from a second external device, and the switch unit disables a connection between the audio reproducing unit and the I/O processing unit.

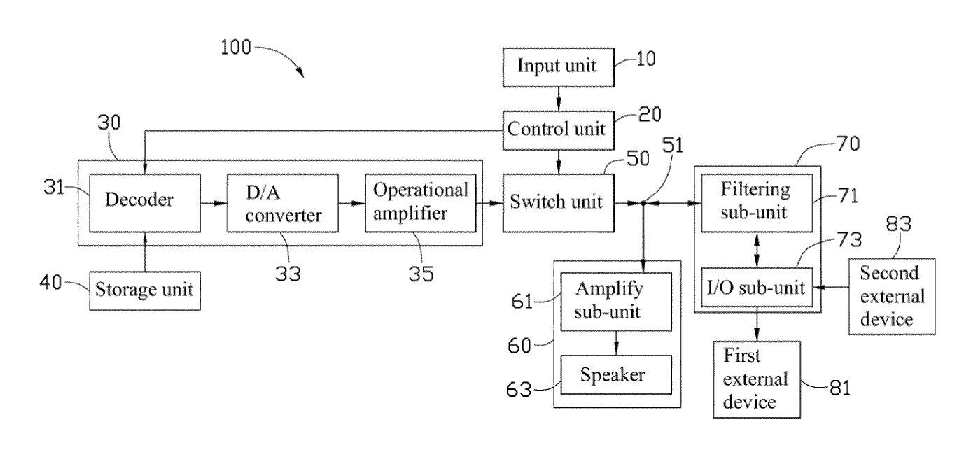

### BACKGROUND

1. Technical Field

The present disclosure relates to audio processing technology and, particularly, to an audio processing system, which can provide high audio effects.

2. Description of Related Art

An audio apparatus may receive external audio signals from an external audio inputting apparatus via an input/output (I/O) processing unit, such as an audio jack. The external audio signals may be outputted to speakers of the audio apparatus. However, before the external audio signals outputting to the speakers, the external audio signals may be attenuated by other circuits of the audio apparatus, such as a sound source circuit that is coupled to the audio jack. Thus, the audio quality of the audio apparatus may not be acceptable.

Therefore, what is needed is an audio processing system, which can provide high audio effects in an audio system.

### BRIEF DESCRIPTION OF THE DRAWINGS

The FIGURE is a functional block diagram of an audio processing system, according to an exemplary embodiment.

### DETAILED DESCRIPTION

Referring to the FIGURE, an audio processing system 100 is used in an audio device, such as a portable digital versatile disc (DVD) player, according to an exemplary embodiment. The audio processing system 100 includes an input unit 10, a control unit 20, an audio reproducing unit 30, a storage unit 40, a switch unit 50, an outputting unit 60, and an input/output (I/O) processing unit 70.

The input unit 10 is configured to receive instructions from a user and generate a first signal or a second signal. The input unit 10 may be a switch which is switchable between a first state and a second state. When the switch is switched to the first state, the input unit 10 electrically connects to a power source and generates the first signal. When the switch is switched to the second state, the input unit 10 electrically connects to ground and generates the second signal.

The control unit 20 is configured to generate a first trigger signal or a second trigger signal, according to the first signal or the second signal, respectively.

The storage unit 40 stores a plurality of audio files, a current gain value V, or other data. The storage unit 40 can be selected from a group consisting of a flash memory storage, a hard disk drive, an optical disk, etc.

The audio reproducing unit 30 is configured to respond to the first trigger signal, decode the plurality of audio files retrieved from the storage unit 40, and generate internal audio signals to the switch unit 50. In this case, the audio reproducing unit 30 includes a decoder 31, a digital to analog (D/A) converter 33, and an operational amplifier 35. The decoder 31 is configured to decode the plurality of audio files retrieved from the storage unit 40, and to generate digital audio signals correspondingly. The D/A converter 33 is configured to convert the digital audio signals to analog audio signals. The operational amplifier 35 is configured to amplify the analog audio signals according to the current gain value V, and to transmit the amplified analog audio signals as the internal audio signals.

The switch unit 50 is configured to selectively establish the connection between the audio reproducing unit 30 and the I/O processing unit 70. When the I/O processing unit 70 is selected to output internal audio signals to a first external device 81 according to the first trigger signal, the switch unit 50 is switched on and establishes the connection between the audio reproducing unit 30 and the I/O processing unit 70. When the I/O processing unit 70 is selected to input external audio signals from a second external device 83 according to the second trigger signal, the switch unit 50 is switched off and disables the connection between the audio reproducing unit 30 and the I/O processing unit 70. The switch unit 50 can be a switch integrated circuit (IC), thereby the switch unit 50 can be controlled by the control unit 20 more easily and automatically. An electrical node 51 is formed by the switch unit 50, the outputting unit 60 and the I/O processing unit 70 cooperatively.

The outputting unit 60 is configured to output the internal audio signals according to the first trigger signal, and output the external audio signals according to the second trigger signal. The outputting unit 60 includes an amplify sub-unit 61 and a speaker 63. The amplify sub-unit 61 is configured to amplify the internal or external audio signals to activate the speaker 63 to output sound. The amplify sub-unit 61 can be a power amplifier.

The I/O processing unit 70 is configured to selectively output the internal audio signals to the first external device 81 according to the first trigger signal, and to input external audio signals from the second external device 83 according to the second trigger signal. The first external device 81 can be an amplifier or a headset, or similar output devices. The second external device 83 can be a microphone or a similar input device. The I/O processing unit 70 includes a filtering sub-unit 71 and an I/O sub-unit 73. The filtering sub-unit 71 is configured to filter the internal audio signals from the switch unit 50 or to filter the external audio signals from the I/O sub-unit 73. The I/O sub-unit 73 is configured to transmit the internal audio signals from the filtering sub-unit 71 to the first external device 81, or to transmit the external audio signals from the second external device 83 to the filtering sub-unit 71. The filtering sub-unit 71 can be a filter circuit. The I/O sub-unit 73 can be an audio jack.

In this embodiment, the audio processing system 100 is in a first mode for outputting internal audio signals according to the first signal, and the audio processing system 100 is in a second mode for receiving external audio signals according to the second signal. When the input unit 10 generates the first signal, the audio processing system 100 is in the first mode, and the control unit 20 responds to the first signal to generate the first trigger signal. According to the first trigger signal, the audio reproducing unit 30 generates the internal audio signals, which the internal audio signals are decoded from the plurality of audio files retrieved from the storage unit 40, and the switch unit 50 is switched on to establish the connection between the audio reproducing unit 30 and the electrical node 51. Thus, the speaker 63 and the I/O sub-unit 73 can output the internal audio signals.

When the input unit 10 generates the second signal, the audio processing system 100 is in the second mode, and the control unit 20 responds to the first signal to generate the second trigger signal. According to the second trigger signal, the switch unit 50 is switched off to disable the connection between the audio reproducing unit 30 and the electrical node 51. As a result, the outputting unit 60 selectively outputs the external audio signals from the second external device 83. The external audio signals are not affected by the audio reproducing unit 30. Thus, the sound quality is improved.

It is to be understood, however, that even though numerous has been described with reference to particular embodiments, but the present invention is not limited to the particular embodiments described and exemplified, and the embodiments are capable of considerable variation and modification without departure from the scope of the appended claims.

What is claimed is:

1. An audio processing system, comprising:
an input unit configured to receive instructions from a user and generate a first signal or a second signal in response to the instructions;
a control unit configured to generate a first trigger signal or a second trigger signal according to the first signal or the second signal, respectively;
an audio reproducing unit configured to decode a plurality of audio files into internal audio signals according to the first trigger signal;
an inputting/outputting (I/O) processing unit configured to selectively output the internal audio signals to a first external device according to the first trigger signal and input external audio signals from a second external device according to the second trigger signal; and
a switch unit configured to establish a connection between the audio reproducing unit and the I/O processing unit when the I/O processing unit is selected to output the internal audio signals according to the first trigger signal, or to disconnect the connection between the audio reproducing unit and the I/O processing unit when the I/O processing unit is selected to input the external audio signals according to the second trigger signal.

2. The audio processing system of claim 1, further comprising:
an outputting unit configured to output the internal audio signals or the external audio signals.

3. The audio processing system of claim 2, wherein an electrical node is formed by the switch unit, the outputting unit and the I/O processing unit cooperatively.

4. The audio processing system of claim 1, further comprising:
a storage unit configured to store the plurality of audio files.

5. The audio processing system of claim 1, wherein the input unit is a switch, which is switchable between a first state and a second state, when the input unit is switched to the first state, the input unit electrically connects to a power source and generates the first signal, when the input unit is switched to the second state, the input unit electrically connects to ground and generates the second signal.

6. The audio processing system of claim 1, wherein the audio processing system is in a first mode when outputting the internal audio signals according to the first signal, and the audio processing system is in a second mode when inputting the external audio signals according to the second signal.

7. The audio processing system of claim 4, wherein the storage unit is selected from a group consisting of a flash storage, a hard disk drive and an optical disk.

8. The audio processing system of claim 1, wherein the audio reproducing unit comprises:
a decoder configured to decode the plurality of audio files and generate digital audio signals correspondingly;
a digital to analog (D/A) converter configured to convert the digital audio signals to analog audio signals; and
an operational amplifier configured to amplify the analog audio signals as the internal audio signals and transmit the internal audio signals to the switch unit.

9. The audio processing system of claim 1, wherein the switch unit is a switch integrated circuit (IC), the switch IC is switched ON to establish the connection between the audio reproducing unit and the I/O processing unit according to the first trigger signal, the switch IC is switched OFF to disable the connection between the audio reproducing unit and the I/O processing unit according to the second triggering signal.

10. The audio processing system of claim 1, wherein the outputting unit comprises an amplify sub-unit and a speaker, the amplify sub-unit is configured to amplify the internal audio signals, the speaker is configured to output the amplified internal audio signals.

11. The audio processing system of claim 10, wherein the amplify sub-unit comprises a power amplifier.

12. The audio processing system of claim 1, wherein the I/O processing unit comprises a filtering sub-unit and an I/O sub-unit, the filtering sub-unit is configured to filter the internal or the external audio signals, and the I/O sub-unit is configured to output the filtered internal audio signals or to input the external audio signals from the second external device.

13. The audio processing system of claim 12, wherein the filtering sub-unit comprises a filter circuit.

14. The audio processing system of claim 12, wherein the I/O sub-unit comprises an audio jack.

15. The audio processing system of claim 1, wherein the audio processing system is a portable digital versatile disc (DVD) having a function of playing the external audio signals from the second external device.

16. An audio processing system capable of reproducing audio signals from an internal audio source and an external audio source, the audio processing system comprising:
an input unit for receiving a first instruction for triggering the audio processing system to reproduce the internal audio signals from the internal audio source, and a second instruction for triggering the audio processing system to reproduce the external audio signals from the external audio source;
an outputting unit for outputting the internal audio signals reproduced from the internal source and the external audio signals reproduced from the external audio source; and
a switch unit for establishing a connection between the internal audio source and the outputting unit, and disconnecting a connection between the external audio source and the internal audio source according to the second instruction.

17. The audio processing system of claim 16, further comprising:
an I/O processing unit, the I/O processing unit is selectively operating as an interface for outputting the internal audio signals reproduced from the internal audio source when the first instruction is inputted, and for inputting the external audio signals from the external audio source when the second instruction is inputted.
